(19) United States
(12) Patent Application Publication
(10) Pub. No.: US 2023/0078743 A1
(43) Pub. Date: Mar. 16, 2023

(54) Insulating Material-Coated Soft Magnetic Powder, Method For Producing Insulating Material-Coated Soft Magnetic Powder, Dust Core, Magnetic Element, Electronic Device, And Moving Body

(71) Applicant: SEIKO EPSON CORPORATION, Tokyo (JP)

(72) Inventor: Akira ARAI, Shimosuwa (JP)

(21) Appl. No.: 17/895,257

(22) Filed: Aug. 25, 2022

(30) Foreign Application Priority Data
Aug. 26, 2021 (JP) 2021-137807

(51) Int. Cl. H01F 1/26

(52) U.S. Cl. CPC H01F 1/26; H01F 27/255

(57) ABSTRACT

An insulating material-coated soft magnetic powder includes: an Fe-based alloy soft magnetic powder; and an insulating film with which a particle surface of the Fe-based alloy soft magnetic powder is coated. D50 is 0.1 μm or more and 3.0 μm or less where D50 is a particle diameter of the Fe-based alloy soft magnetic powder at which a cumulative frequency is 50% in a volume-based particle size distribution, and a ratio of D90/D50 is 2.00 or less where D90 is a particle diameter of the Fe-based alloy soft magnetic powder at which the cumulative frequency is 90% in the volume-based particle size distribution.

The present application is based on, and claims priority from JP Application Serial Number 2021-137807, filed Aug. 26, 2021, the disclosure of which is hereby incorporated by reference herein in its entirety.

### BACKGROUND

### 1. Technical Field

The present disclosure relates to an insulating material-coated soft magnetic powder, a method for producing an insulating material-coated soft magnetic powder, a dust core, a magnetic element, an electronic device, and a moving body.

### 2. Related Art

JP-A-2016-15357 discloses an amorphous alloy powder having a ratio of D90/D10 of 3.3 or more and 6.5 or less and D50 of 5 μm or more and 20 μm or less. D90 is a particle diameter at a cumulation of 90% from a small-diameter side in a volume-based particle size distribution, D10 is a particle diameter at a cumulation of 10%, and D50 is a particle diameter at a cumulation of 50%. Since such an amorphous alloy powder is excellent in filling property during compacting molding, it is possible to produce a dust core having high mechanical strength, saturation magnetic flux density, and magnetic permeability.

In recent years, a communication speed has been improved in various communication devices. Therefore, a magnetic element is often used in a high frequency band of 1 MHz or more. However, in the dust core using the amorphous alloy powder described in JP-A-2016-15357, a core loss in the high frequency band cannot be sufficiently reduced. Therefore, a soft magnetic powder capable of reducing the core loss in the high frequency band of 1 MHz or more, preferably 10 MHz or more is required.

### SUMMARY

An insulating material-coated soft magnetic powder according to an application example of the present disclosure includes: an Fe-based alloy soft magnetic powder; and an insulating film with which a particle surface of the Fe-based alloy soft magnetic powder is coated. D50 is 0.1 μm or more and 3.0 μm or less where D50 is a particle diameter of the Fe-based alloy soft magnetic powder at which a cumulative frequency is 50% in a volume-based particle size distribution, and a ratio of D90/D50 is 2.00 or less where D90 is a particle diameter of the Fe-based alloy soft magnetic powder at which the cumulative frequency is 90% in the volume-based particle size distribution.

A method for producing an insulating material-coated soft magnetic powder according to an application example of the present disclosure includes: an in-liquid classification step of classifying an Fe-based alloy raw material powder in a liquid, and extracting an Fe-based alloy soft magnetic powder that has D50 of 0.1 μm or more and 3.0 μm or less where D50 is a particle diameter thereof at which a cumulative frequency is 50% in a volume-based particle size distribution, and that has a ratio of D90/D50 of 2.00 or less where D90 is a particle diameter thereof at which the cumulative frequency is 90% in the volume-based particle size distribution; and an insulating film formation step of forming an insulating film with which a particle surface of the Fe-based alloy soft magnetic powder is coated.

A dust core according to an application example of the present disclosure contains: the insulating material-coated soft magnetic powder according to the application example of the present disclosure.

A magnetic element according to an application example of the present disclosure includes: the dust core according to the application example of the present disclosure.

An electronic device according to an application example of the present disclosure includes: the magnetic element according to the application example of the present disclosure.

A moving body according to an application example of the present disclosure includes: the magnetic element according to the application example of the present disclosure.

### BRIEF DESCRIPTION OF THE DRAWINGS

FIG. 1 is a cross-sectional view schematically showing one particle of an insulating material-coated soft magnetic powder according to an embodiment.

FIG. 2 is a process diagram showing a method for producing the insulating material-coated soft magnetic powder according to the embodiment.

FIG. 3 is a plan view schematically showing a toroidal type coil component.

FIG. 4 is a transparent perspective view schematically showing a closed magnetic circuit type coil component.

FIG. 5 is a perspective view showing a mobile personal computer, which is an electronic device including a magnetic element according to the embodiment.

FIG. 6 is a plan view showing a smartphone, which is an electronic device including the magnetic element according to the embodiment.

FIG. 7 is a perspective view showing a digital still camera, which is an electronic device including the magnetic element according to the embodiment.

FIG. 8 is a perspective view showing an automobile, which is a moving body including the magnetic element according to the embodiment.

FIG. 9 is a graph obtained by comparing particle size distributions obtained from Fe-based alloy soft magnetic powders in Examples 1 and 2 and Comparative Examples 1 and 2.

FIG. 10 is an observation image of the Fe-based alloy soft magnetic powder in Example 1 obtained by a scanning electron microscope.

FIG. 11 is an observation image of the Fe-based alloy soft magnetic powder in Comparative Example 2 obtained by the scanning electron microscope.

### DESCRIPTION OF EXEMPLARY EMBODIMENTS

Hereinafter, an insulating material-coated soft magnetic powder, a method for producing an insulating material-coated soft magnetic powder, a dust core, a magnetic element, an electronic device, and a moving body according to the present disclosure will be described in detail based on the accompanying drawings.

### 1. Insulating Material-Coated Soft Magnetic Powder

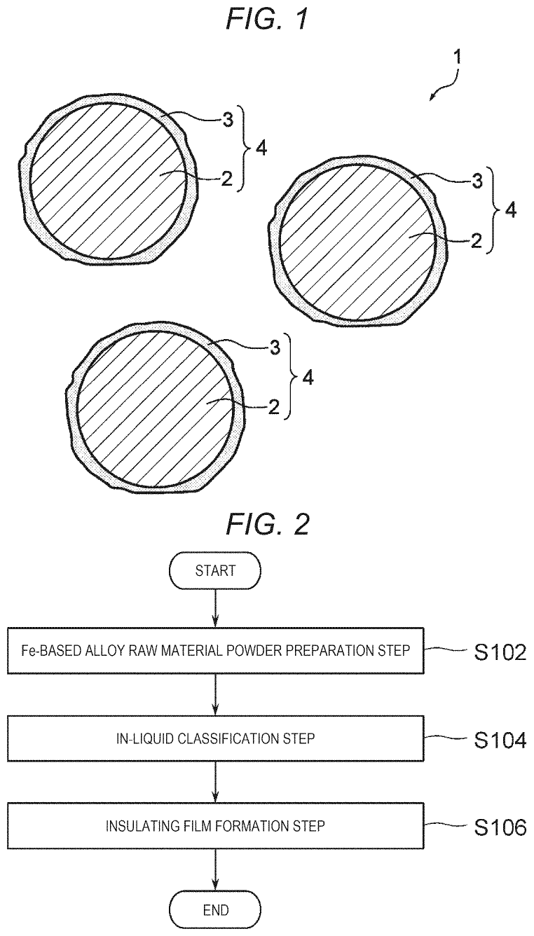

First, an insulating material-coated soft magnetic powder according to an embodiment will be described. FIG. 1 is a cross-sectional view schematically showing one particle of an insulating material-coated soft magnetic powder 1 according to the embodiment. In the following description, one particle of the insulating material-coated soft magnetic powder 1 is also referred to as an “insulating material-coated soft magnetic particle 4”.

The insulating material-coated soft magnetic particle 4 shown in FIG. 1 includes an Fe-based alloy soft magnetic particle 2 and an insulating film 3 provided on a surface of the Fe-based alloy soft magnetic particle 2. Among these, the Fe-based alloy soft magnetic particle 2 contains a soft magnetic material described below. The surface of the Fe-based alloy soft magnetic particle 2 is coated with the insulating film 3, which has an insulating property. The term “coat” in the present description is a concept that includes not only a state in which the entire surface of the Fe-based alloy soft magnetic particle 2 is coated but also a state in which a part of the surface is coated. In the following description, an aggregate of Fe-based alloy soft magnetic particles 2 is also referred to as a “Fe-based alloy soft magnetic powder”.

When a plurality of such insulating material-coated soft magnetic particles 4 are gathered to form a dust core, the insulating property between the particles is increased. Accordingly, an eddy current loss can be reduced in a magnetic element including the dust core. As a result, the insulating material-coated soft magnetic particle 4 contributes to obtaining a magnetic element having a low loss (core loss) in a high frequency band.

### 1.1. Fe-Based Alloy Soft Magnetic Particle

The Fe-based alloy soft magnetic particle 2 contains a soft magnetic material as described above. The soft magnetic material is an Fe-based alloy material containing Fe as a main component, that is, containing 50% or more of Fe in terms of atomic ratio. The soft magnetic material may contain an element exhibiting ferromagnetism alone such as Ni or Co and at least one element selected from the group consisting of Cr, Nb, Cu, Al, Mn, Mo, Si, Sn, B, C, P, Ti, and Zr according to a target property. In addition, the soft magnetic material may contain inevitable impurities as long as effects of the embodiment are not impaired.

The inevitable impurities are impurities that are unintentionally mixed in with raw materials or during production. Examples of the inevitable impurities include O, N, S, Na, Mg, and K.

Specific examples of the soft magnetic material include Fe-Si-based alloys such as silicon steel, Fe-Si-Al-based alloys such as Sendust, and various alloys such as Fe-Ni-based, Fe-Co-based, Fe-Ni-Co-based, Fe-Si-B-based, Fe-Si-B-C-based, Fe-Si-B-Cr-C-based, Fe-Si-Cr-based, Fe-B-based, Fe-P-C-based, Fe-Co-Si-B-based, Fe-Si-B-Nb-based, Fe-Si-B-Nb-Cu-based, Fe-Zr-B-based, Fe-Cr-based, and Fe-Cr-Al-based alloys.

By using the soft magnetic material having such a composition, an insulating material-coated soft magnetic particle 4 having high magnetic permeability, magnetic flux density, and the like and a low coercive force is obtained.

A content of Fe in the soft magnetic material is preferably 70% or more, and more preferably 80% or more in terms of atomic ratio. Accordingly, magnetic properties of the insulating material-coated soft magnetic particle 4, such as the magnetic permeability and the magnetic flux density, can be particularly improved.

A structure constituting the soft magnetic material is not particularly limited, and may be any of a crystalline structure, a non-crystalline (amorphous) structure, and a microcrystalline (nano-crystalline) structure. Among these, the soft magnetic material preferably contains an amorphous or microcrystalline material. By containing the amorphous or microcrystalline material, the coercive force is reduced, which also contributes to a decrease in hysteresis loss of the magnetic element. Structures having different crystallinities may be mixed in the soft magnetic material.

The composition of the soft magnetic material is specified by the following analysis method.

Examples of the analysis method include: iron and steel-atomic absorption spectrometry defined in JIS G 1257:2000; iron and steel-ICP emission spectrometry defined in JIS G 1258:2007; iron and steel-spark discharge emission spectrometry defined in JIS G 1253:2002; iron and steel-X-ray fluorescence analysis defined in JIS G 1256:1997; and weight, titration, and absorption photometry defined in JIS G 1211 to G 1237.

Specific examples of a spectrometer include a solid emission spectrometer manufactured by SPECTRO, in particular, a spark discharge emission spectrometer, model: SPECTROLAB, type: LAVMB08A, and an ICP device CIROS120 type manufactured by Rigaku Corporation.

In particular, when C (carbon) and S (sulfur) are to be specified, an oxygen gas flow combustion (high-frequency induction furnace combustion)-infrared absorption method defined in JIS G 1211:2011 is also used. Specific examples of an analyzer include a carbon-sulfur analyzer CS-200 manufactured by LECO Corporation.

In particular, when N (nitrogen) and O (oxygen) are to be specified, general rules of an iron and steel-nitrogen quantification method defined in JIS G 1228:1997 and a metal material oxygen quantification method defined in JIS Z 2613:2006 are also used. Specific examples of the analyzer include an oxygen-nitrogen analyzer TC-300/EF-300 manufactured by LECO Corporation.

When a particle diameter of the Fe-based alloy soft magnetic powder at which a cumulative frequency is 50% in a volume-based particle size distribution is D50, D50 is 0.1 μm or more and 3.0 μm or less, preferably 0.3 μm or more and 1.5 μm or less, and more preferably 0.5 μm or more and 1.2 μm or less. When D50 of the Fe-based alloy soft magnetic powder is within the above range, a path of an eddy current in the Fe-based alloy soft magnetic particle 2 is shortened, and thus the eddy current loss of the magnetic element in the high frequency band can be sufficiently reduced. When D50 of the Fe-based alloy soft magnetic powder is within the above range, the filling property during compacting is increased, and thus magnetic properties of the magnetic element such as a saturation magnetic flux density can be improved.

When the particle diameter D50 of the Fe-based alloy soft magnetic powder is less than the above lower limit value, aggregation is likely to occur, the formation of the insulating film 3 is difficult, and the filling property during compacting decreases. Accordingly, secondary particles are generated, and an eddy current loss derived from the eddy current between particles increases. Meanwhile, when the particle diameter D50 of the Fe-based alloy soft magnetic powder is more than the above upper limit value, the path of the eddy current in the particles is longer, and thus an eddy current loss derived from the eddy current in the particles increases.

When a particle diameter of the Fe-based alloy soft magnetic powder at which the cumulative frequency is 90% in the volume-based particle size distribution is D90, a ratio of D90/D50 is 2.00 or less, preferably 1.75 or less, and more preferably 1.50 or less. When the ratio of D90/D50 is within the above range, a content ratio of coarse particles is low, and the particle size distribution can be said sufficiently narrow. Thus, in such an Fe-based alloy soft magnetic powder, the generation of the eddy current in the particles caused by the coarse particles can be prevented, and an increase in eddy current loss of the magnetic element in the high frequency band can be prevented. In addition, the deterioration of the filling property during compacting due to the coarse particles can be prevented.

When the ratio of D90/D50 is more than the above upper limit value, the content ratio of the coarse particles is high, and the in-particle eddy current caused by the coarse particles increases. Therefore, when the magnetic element is obtained using the Fe-based alloy soft magnetic powder having the ratio of D90/D50 more than the above upper limit value, the eddy current loss of the magnetic element in the high frequency band increases. In addition, since the filling property of the insulating material-coated soft magnetic powder 1 decreases due to the coarse particles, the magnetic properties of the magnetic element such as a saturation magnetic flux density decrease.

The lower limit value of the ratio of D90/D50 is not particularly set, and is preferably 1.2 or more in consideration of the balance between production cost and properties.

The volume-based particle size distribution of the Fe-based alloy soft magnetic powder can be obtained by, for example, a laser diffraction scattering method.

A cross-sectional shape of the Fe-based alloy soft magnetic particle 2 is not particularly limited and may be, for example, circular, elliptical, or polygonal, and is preferably circular.

Specifically, in the Fe-based alloy soft magnetic powder, a ratio of the Fe-based alloy soft magnetic particle 2 having a circularity of 0.60 or less is preferably 2.0% or less, and more preferably 1.5% or less. In such an Fe-based alloy soft magnetic powder, since a specific surface area thereof can be sufficiently reduced, an area to be coated with the insulating film 3 can also be sufficiently reduced. Accordingly, a volume ratio occupied by the Fe-based alloy soft magnetic powder in the dust core can be increased, and a magnetic element having excellent magnetic properties can be obtained. In addition, since the filling property is also increased, voids are less likely to be generated in the dust core, and a magnetic element having excellent magnetic properties can be obtained from this viewpoint.

When the ratio of the Fe-based alloy soft magnetic particle 2 having a circularity of 0.60 or less is more than the above upper limit value, the uniformity of a density of magnetic field lines formed by the Fe-based alloy soft magnetic particle 2 decreases due to an influence of shape magnetic anisotropy, and the magnetic properties may decrease.

A circularity CI of the Fe-based alloy soft magnetic powder is defined by the following equation (1).

CI=4πS/L² (1)

In the above equation (1), S represents a projected area of the Fe-based alloy soft magnetic particle 2, and L represents a perimeter of the Fe-based alloy soft magnetic particle 2.

The circularity of the Fe-based alloy soft magnetic powder is measured by performing the following image processing on an image of the Fe-based alloy soft magnetic powder.

First, image processing of detecting the contour is performed on an image of a plurality of Fe-based alloy soft magnetic particles 2 obtained by a scanning electron microscope (SEM), an optical microscope, or the like. Accordingly, a particle image is specified. Next, an area and a perimeter of the particle image are measured. Then, the circularity CI is calculated based on the above equation (1). Next, the circularity CI is obtained for each of the plurality of Fe-based alloy soft magnetic particles 2. Then, the ratio of the Fe-based alloy soft magnetic particle 2 having a circularity CI of 0.60 or less in one image is calculated.

Image processing of identifying a particle image from an image can be performed, for example, by using an image processing system ImageJ developed by the National Institutes of Health of the United States.

The coercive force of the Fe-based alloy soft magnetic powder is preferably 800 A/m (10.05 Oe) or less, and more preferably 400 A/m (5.03 Oe) or less. By using the Fe-based alloy soft magnetic powder having such a low coercive force, it is possible to obtain a magnetic element capable of sufficiently preventing a hysteresis loss even when the magnetic element is used in the high frequency band.

The coercive force of the Fe-based alloy soft magnetic powder can be measured by, for example, a magnetization measuring device TM-VSM1230-MHHL manufactured by Tamakawa Co., Ltd.

The saturation magnetization of the Fe-based alloy soft magnetic powder is preferably 1.1 T or more, and more preferably 1.2 T or more. By using the Fe-based alloy soft magnetic powder having such a high saturation magnetization, it is possible to obtain a magnetic element having excellent magnetic properties such as a saturation magnetic flux density. The upper limit value of the saturation magnetization of the Fe-based alloy soft magnetic powder is not particularly limited, and is preferably 2.2 T or less from the viewpoints of a cost and a degree of freedom in selecting the material.

The saturation magnetization of the Fe-based alloy soft magnetic powder can be measured by, for example, a magnetization measuring device TM-VSM1230-MHHL manufactured by Tamakawa Co., Ltd.

The Fe-based alloy soft magnetic powder may be a powder produced by any method. Examples of the method for producing the Fe-based alloy soft magnetic powder include various atomization methods such as a water atomization method, a gas atomization method, and a rotary water atomization method, a reduction method, a carbonyl method, and a pulverization method. Among these, the atomization method is preferably used. That is, the Fe-based alloy soft magnetic powder is preferably an atomized powder. The atomized powder is minute, has high sphericity, and is high in production efficiency. In particular, a water atomized powder or a rotary water atomized powder is produced by the contact between a molten metal and water, and thus a thin oxide film is formed on a surface thereof. Since the oxide film serves as a base for the insulating film 3, an insulating material-coated soft magnetic particle 4 having excellent adhesion between the Fe-based alloy soft magnetic particle 2 and the insulating film 3 and having a high insulating property between the particles can be obtained.

### 1.2. Insulating Film

The surface of the Fe-based alloy soft magnetic particle 2 is coated with the insulating film 3.

The insulating film 3 contains a silicon oxide or a composite oxide containing silicon and at least one selected from the group consisting of Al, Ti, V, Nb, Cr, Mn, and Zr. The silicon oxide is SiOₓ (0<x≤2), and specifically, SiO₂ is preferable. The silicon oxide is chemically stable and has a high insulating property. Therefore, the insulating film 3 containing the silicon oxide can reduce the eddy current between particles even if a thickness thereof is thin. When Al, Ti, V, Nb, Cr, Mn, and Zr form a composite oxide with silicon, an insulating film 3 having chemical stability and insulating property equal to or higher than those of the silicon oxide can be obtained. Therefore, such an insulating film 3 contributes to obtaining the insulating material-coated soft magnetic particle 4 from which a magnetic element having excellent magnetic properties and a reduced eddy current loss can be produced.

The insulating film 3 may include a plurality of layers composed of oxides of different types.

Further, the insulating film 3 may contain inevitable impurities as long as the above-mentioned effects are not impaired. Examples of the inevitable impurities include C, N, and P.

An average thickness of the insulating film 3 is preferably 1 nm or more and 100 nm or less, and more preferably 3 nm or more and 50 nm or less. Accordingly, it is possible to increase a filling rate of an Fe-based alloy in the dust core to a certain level or more while sufficiently ensuring the insulating property and heat resistance of the insulating film 3. When the average thickness of the insulating film 3 is less than the above lower limit value, the insulating property and the heat resistance of the insulating film 3 may be insufficient depending on constituent materials of the insulating film 3. Meanwhile, when the thickness of the insulating film 3 is more than the above upper limit value, the insulating film 3 may be easily peeled off, or the filling rate of the Fe-based alloy in the dust core may decrease depending on the constituent materials of the insulating film 3.

The average thickness of the insulating film 3 is measured by, for example, observing a cross section of the insulating material-coated soft magnetic particle 4 in an enlarged manner. Specifically, the insulating material-coated soft magnetic particle 4 is cut with a focused ion beam to prepare a thin cross-sectional sample. Next, the obtained thin cross-sectional sample is observed with a scanning transmission electron microscope, and the thickness of the insulating film 3 is measured at 5 or more points per particle. Then, the measured values are averaged, and the calculated result is taken as the average thickness of the insulating film 3.

A configuration of the insulating film 3 can be confirmed by, for example, EDX analysis (energy dispersive X-ray analysis), Auger electron spectroscopy measurement, or the like.

As described above, the insulating material-coated soft magnetic powder 1 according to the present embodiment includes the Fe-based alloy soft magnetic powder and the insulating film 3 with which a surface of the particle of the Fe-based alloy soft magnetic powder (Fe-based alloy soft magnetic particle 2) is coated. When the particle diameter of the Fe-based alloy soft magnetic powder at which the cumulative frequency in the volume-based particle size distribution is 50% is D50, D50 is 0.1 μm or more and 3.0 μm or less in the present embodiment. When the particle diameter of the Fe-based alloy soft magnetic powder at which the cumulative frequency in the volume-based particle size distribution is 90% is D90, the ratio of D90/D50 is 2.00 or less in the present embodiment.

According to such a configuration, the path of the eddy current in the Fe-based alloy soft magnetic particle 2 can be shortened, and the particle size distribution of the Fe-based alloy soft magnetic powder can be sufficiently narrowed. Therefore, it is possible to obtain the insulating material-coated soft magnetic powder 1 from which a magnetic element having a sufficiently reduced eddy current loss in the high frequency band can be produced.

2. Method for Producing Insulating Material-Coated Soft Magnetic Powder

Next, a method for producing the insulating material-coated soft magnetic powder according to the embodiment will be described. FIG. 2 is a process diagram showing a method for producing the insulating material-coated soft magnetic powder according to the embodiment.

The method for producing the insulating material-coated soft magnetic powder shown in FIG. 2 includes an Fe-based alloy raw material powder preparation step S102, an in-liquid classification step S104, and an insulating film formation step S106.

2.1. Fe-Based Alloy Raw Material Powder Preparation Step

In the Fe-based alloy raw material powder preparation step S102, first, an Fe-based alloy raw material powder is prepared by the above-mentioned atomization method or the like.

The atomization method is divided into a water atomization method, a rotary water atomization method, a gas atomization method, and the like depending on the type of a cooling medium and a difference in device configuration. The atomization method is a method for preparing a metal powder by causing a molten metal to collide with a liquid or a gas injected at a high speed so as to pulverize the molten metal, and cooling the obtained substance.

Among these, in the water atomization method, the molten metal is split in the air by a large negative pressure to form fine droplets. Thereafter, the fine droplets are rapidly cooled and solidified by a high-speed jet water to obtain a metal powder having a shape similar to a sphere. Therefore, the water atomization method is particularly suitable as a method for preparing the Fe-based alloy raw material powder. Since a cooling rate is high, it is possible to prepare an Fe-based alloy raw material powder containing an amorphous structure or a microcrystalline structure.

When a commercially available Fe-based alloy raw material powder is procured, this step can be omitted.

### 2.2. In-Liquid Classification Step

In the in-liquid classification step S104, the Fe-based alloy raw material powder is classified in a liquid. Accordingly, an Fe-based alloy soft magnetic powder that has D50 of 0.1 μm or more and 3.0 μm or less and that has a ratio of D90/D50 of 2.00 or less is extracted. The classification in the liquid is also referred to as wet classification. On the other hand, the classification in the air is also called dry classification. The dry classification uses a difference in mechanical behavior of particles in air to classify the particles, whereas the wet classification performed in the liquid uses a centrifugal force, gravity, or the like in the liquid to classify the particles. Therefore, the wet classification performed in the liquid can lead to a result with high accuracy even in a size of sub-micron order, and the aggregation of the classified particles can be prevented as compared with the dry classification.

Specifically, it is preferable that the in-liquid classification step includes an operation of classifying the Fe-based alloy raw material powder by a centrifugal force or gravity. High classification accuracy is obtained both in a centrifugal force field and a gravity field. From the viewpoint of more accurate classification, it is more preferable that the in-liquid classification step includes an operation of classifying the Fe-based alloy raw material powder by gravity.

The operation of classifying the Fe-based alloy raw material powder by gravity is a classification operation utilizing the fact that a settling rate of the particle in the liquid differs depending on a size (particle diameter) of the particle, and can be performed by using, for example, an upright cylindrical wet classifier. The settling rate for each particle size (particle diameter) is obtained in advance, and the particles are collected from the classifier in accordance with the settling time, whereby a metal powder having a desired particle diameter can be obtained.

When the Fe-based alloy raw material powder is classified in a liquid, the liquid preferably contains a dispersant. By adding the dispersant, aggregation of particles in the liquid can be prevented. Examples of the dispersant include a carboxylate-based dispersant and a sulfonate-based dispersant.

An addition amount of the dispersant is not particularly limited, and is preferably 0.1 parts by mass or more and 5.0 parts by mass or less, and more preferably 0.2 parts by mass or more and 3.0 parts by mass or less with respect to 100 parts by mass of the Fe-based alloy raw material powder.

### 2.3. Insulating Film Formation Step

In the insulating film formation step S106, the insulating film 3 with which the particle surface is coated is formed with respect to the Fe-based alloy soft magnetic powder extracted in the in-liquid classification step S104. Accordingly, the insulating material-coated soft magnetic powder is obtained.

A method for forming the insulating film 3 is not particularly limited, and examples thereof include a wet formation method such as a sol-gel method and an electrolytic reduction method, and a dry formation method such as atomic layer deposition (ALD), chemical vapor deposition (CVD), and ion plating. Among these, the sol-gel method is preferably used, and a Stober method, which is a kind of sol-gel method, is more preferably used.

The Stober method is a method for forming monodisperse particles by hydrolyzing a metal alkoxide. For example, when the insulating film 3 is formed of a silicon oxide, a hydrolysis reaction of a silicon alkoxide using the Stober method can be utilized. Hereinafter, a method using a silicon alkoxide will be described.

Specifically, first, the Fe-based alloy soft magnetic powder is dispersed in an alcohol solution containing a silicon alkoxide. Examples of the alcohol solution include lower alcohols such as ethanol and methanol. For example, 10 parts by mass or more and 50 parts by mass or less of an alcohol may be mixed with 1 part by mass of tetraethoxysilane. From the viewpoint of forming a uniform film on the particle surface, 0.01 parts by mass or more and 0.1 parts by mass or less of a silicon alkoxide may be mixed with 1 part by mass of the Fe-based alloy soft magnetic powder. As the silicon alkoxide, for example, tetraethoxysilane (TEOS, Si(OC₂H₅)₄) is preferably used.

Next, as a catalyst for accelerating a reaction, aqueous ammonia is mixed to cause hydrolysis. Accordingly, a dehydration condensation reaction occurs between hydrolysates or between the hydrolyzate and the silicon alkoxide, and a bond of —Si—O—Si— is formed on the particle surface. Accordingly, a silicon oxide film is formed.

Before or after the aqueous ammonia is mixed, the Fe-based alloy soft magnetic powder and the alcohol solution may be stirred using an ultrasound application device or the like. By performing such stirring, uniform dispersion of the particles can be promoted, and a silicon oxide film can be formed more uniformly on the particle surface. The stirring is preferably performed for a period of time longer than a period of time during which the hydrolysis reaction of the silicon alkoxide sufficiently proceeds.

In the above description, the Fe-based alloy soft magnetic powder is dispersed in the alcohol solution containing a silicon alkoxide, and then the aqueous ammonia is mixed thereto, but the order of mixing the aqueous ammonia is not limited thereto. For example, the aqueous ammonia may be mixed with the alcohol solution in which the Fe-based alloy soft magnetic powder is dispersed, and then the alcohol solution containing a silicon alkoxide may be mixed thereto. In such a case, the alcohol solution containing a silicon alkoxide may be added several times. When the alcohol solution containing a silicon alkoxide is added several times, the above-described stirring may be performed every time the alcohol solution is added, or the alcohol solution may be added to the solution under stirring.

The thickness of the insulating film 3 can be adjusted by a concentration of the silicon alkoxide in the solution. For example, when the concentration of the silicon alkoxide in the solution is high, the thickness of the insulating film 3 is high, but when the concentration is excessively high, an excessive silicon oxide may be precipitated alone. Therefore, the concentration of the silicon alkoxide in the solution is preferably adjusted within the above range.

After the insulating film 3 is formed, the obtained insulating material-coated soft magnetic powder may be subjected to a heat treatment as necessary. Conditions in the heat treatment are, for example, a temperature of 60° C. or higher and 120° C. or lower and a time of 10 minutes or longer and 300 minutes or shorter. Accordingly, a hydrate remaining on the insulating film 3 can be removed, and the adhesion of the insulating film 3 can be improved.

In the method for producing the insulating material-coated soft magnetic powder according to the present embodiment, another classification step may be performed between the Fe-based alloy raw material powder preparation step S102 and the in-liquid classification step S104. In this classification step, coarse particles contained in the Fe-based alloy raw material powder are removed in advance. Accordingly, the classification accuracy in the in-liquid classification step can be improved.

In the above description, the insulating film formation step S106 is performed after the in-liquid classification step S104, but this order may be reversed.

As described above, the method for producing the insulating material-coated soft magnetic powder according to the present embodiment includes the in-liquid classification step S104 and the insulating film formation step S106. In the in-liquid classification step S104, the Fe-based alloy raw material powder is classified in the liquid, and an Fe-based alloy soft magnetic powder that has D50 of 0.1 μm or more and 3.0 μm or less where D50 is the particle diameter thereof at which the cumulative frequency is 50% in the volume-based particle size distribution, and that has a ratio of D90/D50 of 2.00 or less where D90 is the particle diameter thereof at which the cumulative frequency is 90% in the volume-based particle size distribution is extracted. In the insulating film formation step S106, the insulating film 3 with which the particle surface of the Fe-based alloy soft magnetic powder (Fe-based alloy soft magnetic particles 2) is coated is formed.

According to such a configuration, the Fe-based alloy soft magnetic powder in which D50 and the ratio of D90/D50 are optimized by the classification in the liquid can be extracted with high accuracy. Thus, in the insulating material-coated soft magnetic powder containing the Fe-based alloy soft magnetic powder in which the particle size distribution is controlled with high accuracy, the path of the eddy current in the Fe-based alloy soft magnetic particles 2 is sufficiently short, and the particle size distribution of the Fe-based alloy soft magnetic powder is sufficiently narrow. Therefore, according to this producing method, it is possible to produce an insulating material-coated soft magnetic powder from which a magnetic element having a sufficiently reduced eddy current loss in the high frequency band can be obtained.

### 3. Dust Core and Magnetic Element

Next, a dust core and a magnetic element according to the embodiment will be described.

The magnetic element according to the embodiment can be applied as various magnetic elements including a magnetic core, such as a choke coil, an inductor, a noise filter, a reactor, a transformer, a motor, an actuator, an electromagnetic valve, and an electric generator. In addition, the dust core according to the embodiment can be applied to a magnetic core included in these magnetic elements.

Hereinafter, two kinds of coil components will be representatively described as an example of the magnetic element.

### 3.1. Toroidal Type

First, a toroidal type coil component, which is an example of the magnetic element according to the embodiment, will be described.

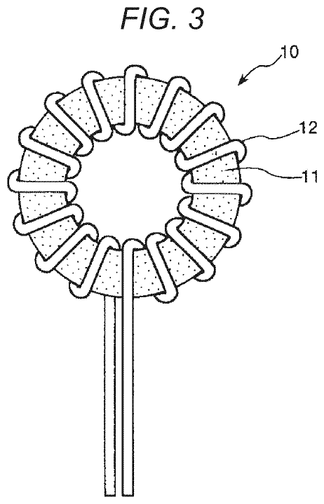

FIG. 3 is a plan view schematically showing the toroidal type coil component.

A coil component 10 shown in FIG. 3 includes a ring-shaped dust core 11 and a conductive wire 12 wound around the dust core 11. Such a coil component 10 is generally referred to as a toroidal coil.

The dust core 11 is obtained by mixing the insulating material-coated soft magnetic powder according to the embodiment and a binder, supplying the obtained mixture to a mold, and pressing and molding the mixture. That is, the dust core 11 is a compacted body containing the insulating material-coated soft magnetic powder according to the embodiment. From such a dust core 11, it is possible to obtain a magnetic element in which the filling property of the insulating material-coated soft magnetic powder is good and the eddy current loss is small when used in the high frequency band. Therefore, the coil component 10 including the dust core 11 has a low eddy current loss and high magnetic properties such as magnetic permeability and magnetic flux density. As a result, when the coil component 10 is mounted on an electronic device or the like, it is possible to reduce power consumption of the electronic device or the like and achieve high performance and miniaturization of the electronic device or the like.

Examples of a constituent material of the binder used in the preparation of the dust core 11 include organic materials such as silicone-based resins, epoxy-based resins, phenol-based resins, polyamide-based resins, polyimide-based resins, and polyphenylene sulfide-based resins, and inorganic materials such as phosphates, for example, magnesium phosphate, calcium phosphate, zinc phosphate, manganese phosphate, and cadmium phosphate, and silicates, for example, sodium silicate. In particular, the constituent material is preferably a thermosetting polyimide or an epoxy-based resin. These resin materials are easily cured by heating and have excellent heat resistance. Therefore, the easiness of preparation and the heat resistance of the dust core 11 can be improved. The binder may be added as necessary, and or may be omitted.

In addition, a ratio of the binder to the insulating material-coated soft magnetic powder slightly varies depending on target magnetic properties and mechanical properties of the dust core 11 to be prepared, the acceptable eddy current loss, and the like, and is preferably about 0.5 mass % or more and 5.0 mass % or less, and more preferably about 1.0 mass % or more and 3.0 mass % or less. Accordingly, it is possible to obtain the coil component 10 having excellent magnetic properties while sufficiently binding the particles of the insulating material-coated soft magnetic powder to each other.

Various additives may be added to the mixture as necessary for any purpose.

Examples of a constituent material of the conductive wire 12 include a material having high conductivity, for example, a metal material containing Cu, Al, Ag, Au, and Ni. An insulating film is provided on a surface of the conductive wire 12 as necessary.

A shape of the dust core 11 is not limited to the ring shape shown in FIG. 3, and may be, for example, a shape in which a part of the ring is missing, a shape in which the shape in a longitudinal direction is linear, a sheet shape, a film shape, or the like.

In addition, the dust core 11 may contain a soft magnetic powder other than the above insulating material-coated soft magnetic powder according to the embodiment or a non-magnetic powder as necessary.

For example, the dust core 11 may further contain a large-diameter soft magnetic powder having an average particle diameter larger than that of the Fe-based alloy soft magnetic powder. Accordingly, the filling property in the dust core 11 can be further improved. That is, since the particles of the Fe-based alloy soft magnetic powder are arranged so as to fill the gaps between the particles of the large-diameter soft magnetic powder, the filling property tends to be higher than that in a case where the dust core 11 is formed by the insulating material-coated soft magnetic powder alone. Meanwhile, by adjusting an addition amount of the large-diameter soft magnetic powder, an increase in eddy current loss in the coil component 10 (magnetic element) can be minimized. As a result, it is possible to obtain the coil component 10 in which the improvement of the magnetic properties and the prevention of the eddy current loss are highly balanced.

The large-diameter soft magnetic powder refers to a powder having an average particle diameter larger than that of the Fe-based alloy soft magnetic powder. Specifically, the particle diameter D50 of the large-diameter soft magnetic powder is preferably larger than the particle diameter D50 of the Fe-based alloy soft magnetic powder by 3.0 μm or more and 30.0 μm or less, and more preferably 5.0 μm or more and 20.0 μm or less. Accordingly, the increase in eddy current loss in the magnetic element can be minimized, while the filling property can be further improved.

A constituent material of the large-diameter soft magnetic powder may be the same as or different from that of the Fe-based alloy soft magnetic powder.

Further, a structure contained in the large-diameter soft magnetic powder may be the same as or different from the structure contained in the Fe-based alloy soft magnetic powder. Examples of the latter include an example in which the Fe-based alloy soft magnetic powder contains an amorphous structure while the large-diameter soft magnetic powder contains a crystalline structure or a microcrystalline structure.

A mixing ratio of the insulating material-coated soft magnetic powder to the large-diameter soft magnetic powder is not particularly limited, and is preferably 0.5:9.5 or more and 9.5:0.5 or less, more preferably 1.0:9.0 or more and 5.0:5.0 or less, and still more preferably 1.0:9.0 or more and 4.0:6.0 or less in terms of mass ratio. Accordingly, a quantitative balance between the insulating material-coated soft magnetic powder and the large-diameter soft magnetic powder is optimized. As a result, it is possible to obtain the coil component 10 in which the improvement of the magnetic properties and the prevention of the eddy current loss are highly balanced.

As described above, the coil component 10, which is a magnetic element, includes the dust core 11 containing the above insulating material-coated soft magnetic powder. Accordingly, the coil component 10 having a low eddy current loss and excellent magnetic properties can be obtained.

### 3.2. Closed Magnetic Circuit Type

Next, a closed magnetic circuit type coil component, which is an example of the magnetic element according to the embodiment, will be described.

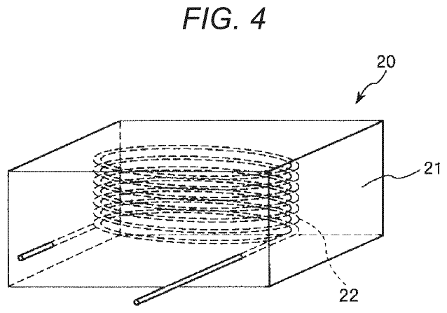

FIG. 4 is a transparent perspective view schematically showing the closed magnetic circuit type coil component.

Hereinafter, the closed magnetic circuit type coil component will be described, and in the following description, differences from the toroidal type coil component will be mainly described, and descriptions of the same matters will be omitted.

As shown in FIG. 4, a coil component 20 according to the present embodiment is formed by embedding a conductive wire 22 formed in a coil shape in a dust core 21. That is, the coil component 20 which is a magnetic element includes the dust core 21 containing the above insulating material-coated soft magnetic powder, and is formed by molding the conductive wire 22 with the dust core 21. The dust core 21 has the same configuration as that of the above dust core 11. Accordingly, the coil component 20 having an eddy current loss and excellent magnetic properties can be obtained.

The coil component 20 in such a form can be easily obtained with a relatively small size. In addition, the coil component 20 has high magnetic properties and a low eddy current loss. Therefore, when the coil component 20 is mounted on an electronic device or the like, it is possible to reduce power consumption of the electronic device or the like and achieve high performance and miniaturization of the electronic device or the like.

Since the conductive wire 22 is embedded in the dust core 21, a gap is less likely to occur between the conductive wire 22 and the dust core 21. Therefore, vibration due to magnetostriction of the dust core 21 can be prevented, and generation of noise due to the vibration can also be prevented.

A shape of the dust core 21 is not limited to the shape shown in FIG. 4, and may be a sheet shape, a film shape, or the like.

In addition, the dust core 21 may contain a soft magnetic powder other than the above insulating material-coated soft magnetic powder according to the embodiment or a non-magnetic powder as necessary.

### 4. Electronic Device

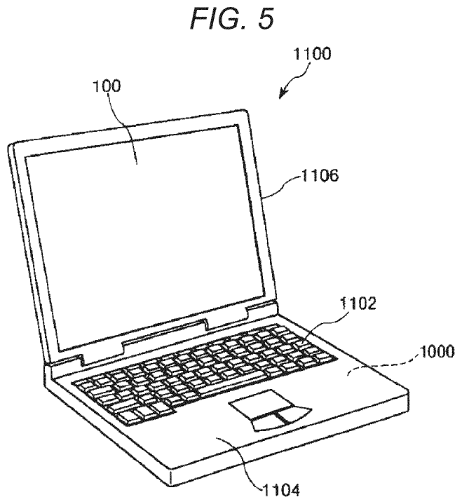

Next, an electronic device including the magnetic element according to the embodiment will be described with reference to FIGS. 5 to 7.

FIG. 5 is a perspective view showing a mobile personal computer, which is an electronic device including the magnetic element according to the embodiment. A personal computer 1100 shown in FIG. 5 includes a main body 1104 including a keyboard 1102 and a display unit 1106 including a display portion 100. The display unit 1106 is rotatably supported by the main body 1104 via a hinge structure. Such a personal computer 1100 is incorporated with a magnetic element 1000 such as a choke coil for a switching power supply, an inductor, and a motor.

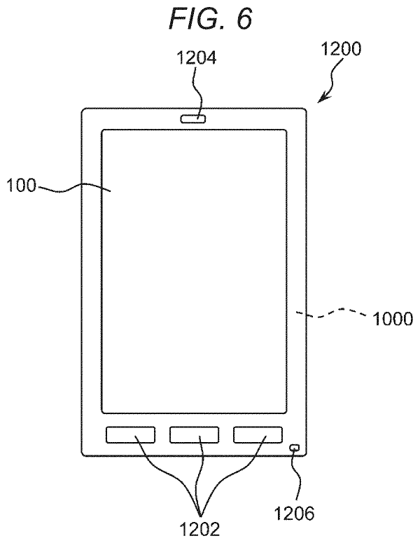

FIG. 6 is a plan view showing a smartphone, which is an electronic device including the magnetic element according to the embodiment. A smartphone 1200 shown in FIG. 6 includes a plurality of operation buttons 1202, an earpiece 1204, and a mouthpiece 1206. The display portion 100 is disposed between the operation buttons 1202 and the earpiece 1204. Such a smartphone 1200 is incorporated with the magnetic element 1000 such as an inductor, a noise filter, and a motor.

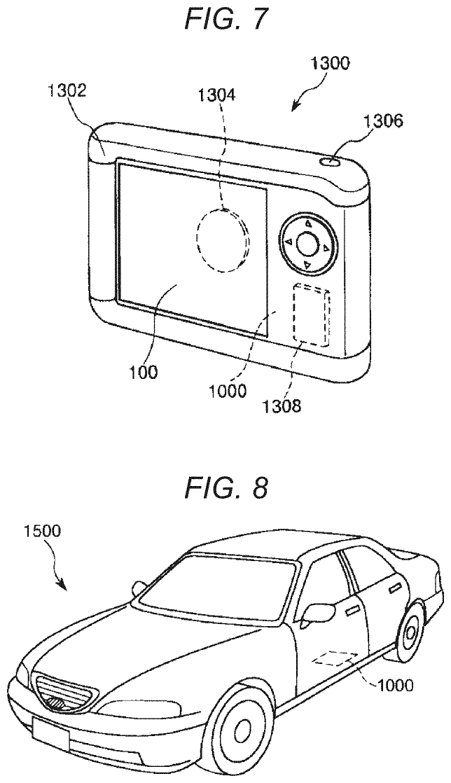

FIG. 7 is a perspective view showing a digital still camera, which is an electronic device including the magnetic element according to the embodiment. A digital still camera 1300 photoelectrically converts an optical image of a subject by an imaging element such as a charge coupled device (CCD) to generate an imaging signal.

The digital still camera 1300 shown in FIG. 7 includes the display portion 100 provided on a rear surface of a case 1302. The display portion 100 functions as a finder on which the subject is displayed as an electronic image. In addition, a light receiving unit 1304 including an optical lens, a CCD, and the like is provided on a front surface side of the case 1302, that is, on a back surface side in the drawing.

When a photographer confirms a subject image displayed on the display portion 100 and presses a shutter button 1306, an imaging signal generated by the CCD at this time is transferred to and stored in a memory 1308. Such a digital still camera 1300 is also incorporated with the magnetic element 1000 such as an inductor or a noise filter.

Examples of the electronic device according to the embodiment include, in addition to the personal computer in FIG. 5, the smartphone in FIG. 6, and the digital still camera in FIG. 7, a mobile phone, a tablet terminal, a watch, inkjet ejection devices such as an inkjet printer, a laptop personal computer, a television, a video camera, a video tape recorder, a car navigation device, a pager, an electronic notebook, an electronic dictionary, a calculator, an electronic game device, a word processor, a workstation, a videophone, a crime prevention television monitor, electronic binoculars, a POS terminal, medical devices such as an electronic thermometer, a blood pressure meter, a blood glucose meter, an electrocardiogram measuring device, an ultrasonic diagnostic device, and an electronic endoscope, a fish finder, various measuring devices, instruments for a vehicle, an aircraft, and a ship, moving body control devices such as an automobile control device, an aircraft control device, a railway vehicle control device, and a ship control device, and a flight simulator.

As described above, such an electronic device includes the magnetic element according to the embodiment. Accordingly, it is possible to exert effects of the magnetic element including the low eddy current loss in the high frequency band, and achieve high performance and miniaturization of the electronic device.

### 5. Moving Body

Next, a moving body including the magnetic element according to the present embodiment will be described with reference to FIG. 8.

FIG. 8 is a perspective view showing an automobile, which is a moving body including the magnetic element according to the embodiment.

An automobile 1500 is incorporated with the magnetic element 1000. Specifically, the magnetic element 1000 is incorporated in various automobile parts such as a car navigation system, an anti-lock brake system (ABS), an engine control unit, a battery control unit for a hybrid vehicle or an electric vehicle, a vehicle body posture control system, an electronic control unit (ECU) such as an automatic driving system, a driving motor, a generator, and an air conditioning unit.

As described above, such a moving body includes the magnetic element according to the embodiment. Accordingly, it is possible to exert effects of the magnetic element including the low eddy current loss in the high frequency band, and achieve high performance and miniaturization of the electronic device mounted on the moving body.

The moving body according to the present embodiment may be, in addition to the automobile shown in FIG. 8, for example, a motorcycle, a bicycle, an aircraft, a helicopter, a drone, a ship, a submarine, a railway, a rocket, and a spacecraft.

The insulating material-coated soft magnetic powder, the method for producing the insulating material-coated soft magnetic powder, the dust core, the magnetic element, the electronic device, and the moving body according to the present disclosure have been described above based on the preferred embodiment, but the present disclosure is not limited thereto.

For example, in the above embodiment, a compacted body such as a dust core has been described as an application example of the insulating material-coated soft magnetic powder according to the present disclosure, but the present disclosure is not limited thereto. The insulating material-coated soft magnetic powder may be applied to a magnetic fluid, and a magnetic device such as a magnetic head and a magnetic shielding sheet. In addition, the shapes of the dust core and the magnetic element are not limited to those shown in the drawings, and may be any shape.

Further, the method for producing the insulating material-coated soft magnetic powder according to the present disclosure may be added with any desired step to the above embodiment.

### EXAMPLES

Next, specific examples of the present disclosure will be described.

### 6. Preparation of Insulating Material-coated Soft Magnetic Powder

### 6.1. Example 1

First, an Fe-based alloy raw material powder having a composition and a crystal structure shown in Table 1 was produced by the water atomization method. Next, the obtained Fe-based alloy raw material powder was classified in a liquid using gravity. Hereinafter, the classification method will be described in detail.

In the classification method in a liquid using gravity, first, 30 g of an Fe-based alloy raw material powder having a particle diameter D50 of about 3 μm was charged into 400 mL of pure water and dispersed by ultrasonic waves to prepare a raw material powder dispersion. Next, the raw material powder dispersion was slowly charged into 1600 mL of pure water to obtain a slurry, and the slurry was allowed to stand for 330 minutes for classification. Thereafter, 600 mL of the slurry was collected from the liquid surface with a siphon. The collected slurry was heated and dried at 85° C. for 120 minutes to volatilize moisture, thereby obtaining an Fe-based alloy soft magnetic powder.

Here, the volume-based particle size distribution of the Fe-based alloy soft magnetic powder after classification was obtained by a laser diffraction scattering particle size distribution measuring device. Then, the particle diameter D50 and the particle diameter D90 were obtained based on the obtained particle size distribution. The ratio of D90/D50 was calculated. Calculation results are shown in Table 1.

Further, the circularity CI of the Fe-based alloy soft magnetic powder after classification was measured based on an observation image obtained by the scanning electron microscope. Then, a ratio of the Fe-based alloy soft magnetic particle having a circularity CI of 0.60 or less was calculated. Calculation results are shown in Table 1.

The coercive force and the saturation magnetization of the Fe-based alloy soft magnetic powder after classification were measured using a VSM system TM-VSM1230-MHHL manufactured by Tamakawa Co., Ltd. serving as a magnetization measuring device. Measurement results are shown in Table 1.

Next, an insulating film made of silicon oxide (SiO₂) having an average thickness of 20 nm was formed on the particle surface of the Fe-based alloy soft magnetic powder after classification by the following method to obtain an insulating material-coated soft magnetic powder.

In the method for forming the insulating film, first, 100 g of the Fe-based alloy soft magnetic powder was dispersed and mixed in 950 mL of ethanol to prepare a mixed solution. Next, the mixed solution was irradiated with ultrasonic waves and stirred for 20 minutes. After stirring, a mixed solution containing 30 mL of pure water and 180 mL of aqueous ammonia was added, and the mixture was further stirred for 10 minutes. Thereafter, a mixed solution containing 3.3 mL of tetraethoxysilane and 100 mL of ethanol was further added, and the mixture was stirred for 120 minutes to form a silicon oxide film on the surface of the Fe-based alloy soft magnetic particles.

The Fe-based alloy soft magnetic particles on which the silicon oxide film was formed were washed with ethanol and acetone. After washing, the resultant was dried at 65° C. for 30 minutes, and further heated at 200° C. for 90 minutes. Accordingly, an insulating material-coated soft magnetic powder was obtained.

### 6.2. Example 2

First, an Fe-based alloy raw material powder having a composition and a crystal structure shown in Table 1 was prepared by the water atomization method. Next, the obtained Fe-based alloy raw material powder was classified in a liquid using a centrifugal force. Hereinafter, the classification method will be described in detail.

In the classification method in a liquid using a centrifugal force, first, an Fe-based alloy raw material powder having a particle diameter D50 of about 3 μm was charged into pure water and dispersed at a content of 7 mass % to prepare a raw material powder dispersion. Next, the raw material powder dispersion was classified by a wet rotary classification device. The obtained Fe-based alloy raw material powder after classification was heated and dried at 85° C. for 120 minutes to volatilize moisture, thereby obtaining an Fe-based alloy soft magnetic powder.

Next, an insulating film was formed in the same manner as in Example 1 to obtain an insulating material-coated soft magnetic powder.

### 6.3. Examples 3 to 6

First, Fe-based alloy raw material powders having compositions and crystal structures shown in Table 1 were prepared by preparation methods shown in Table 1. Next, the obtained Fe-based alloy raw material powders were classified by the methods shown in Table 1 to obtain Fe-based alloy soft magnetic powders.

### 6.4. Comparative Example 1

First, an Fe-based alloy raw material powder having a composition and a crystal structure shown in Table 1 was prepared by the water atomization method. Next, the obtained Fe-based alloy raw material powder was classified in air. Specifically, the Fe-based alloy raw material powder having a particle diameter D50 of about 10 μm was classified by a cyclone classifier, and a classification point was adjusted.

Thereafter, an insulating film was formed on the particle surface of the Fe-based alloy raw material powder after classification by the same method as in Example 1 to obtain an insulating material-coated soft magnetic powder.

### 6.5. Comparative Examples 2 to 6

First, Fe-based alloy raw material powders having compositions and crystal structures shown in Table 1 were prepared by preparation methods shown in Table 1. Next, the obtained Fe-based alloy raw material powders were classified by the methods shown in Table 1 to obtain Fe-based alloy soft magnetic powders.

TABLE 1

| | Configuration of Fe-based alloy soft magnetic powder | | | | |
|---|---|---|---|---|---|
| | Alloy | Crystal | Preparation | Classification | |
| | composition | structure | method | method | D50 |
| | [atomic ratio %] | — | — | — | μm |
| Example 1 | Fe_{73.0}Cr_{2.2}Si_{11.1}B_{10.8}C_{2.9} | Non-crystalline | Water atomization | In liquid/ gravity | 0.75 |
| | | (amorphous) | method | | |
| Example 2 | Fe_{73.0}Cr_{2.2}Si_{11.1}B_{10.8}C_{2.9} | Non-crystalline | Water atomization | In liquid/centrifugal | 0.93 |
| | | (amorphous) | method | | |
| Example 3 | Fe_{73.5}Cu₁Nb₃Si_{13.5}B₉ | Microcrystalline | Rotary water | In liquid/gravity | 0.52 |
| | | (nano-crystalline) | atomization method | | |
| Example 4 | Fe_{73.5}Cu₁Nb₃Si_{13.5}B₉ | Microcrystalline | Rotary water | In liquid/centrifugal | 0.64 |
| | | (nano-crystalline) | atomization method | | |
| Example 5 | Fe_{93.3}Si_{6.7} | Crystalline | Water atomization | In liquid/gravity | 0.50 |
| | | | method | | |
| Example 6 | Fe_{93.3}Si_{6.7} | Crystalline | Water atomization | In liquid/centrifugal | 1.20 |
| | | | method | | |
| Comparative | Fe_{73.0}Cr_{2.2}Si_{11.1}B_{10.8}C_{2.9} | Non-crystalline | Water atomization | In air/gas flow | 3.51 |
| Example 1 | | (amorphous) | method | | |
| Comparative | Fe_{73.0}Cr_{2.2}Si_{11.1}B_{10.8}C_{2.9} | Non-crystalline | Water atomization | In air/gas flow | 0.85 |
| Example 2 | | (amorphous) | method | | |
| Comparative | Fe_{73.5}Cu₁Nb₃Si_{13.5}B₉ | Microcrystalline | Rotary water | In air/gas flow | 5.60 |
| Example 3 | | (nano-crystalline) | atomization method | | |
| Comparative | Fe_{73.5}Cu₁Nb₃Si_{13.5}B₉ | Microcrystalline | Rotary water | In air/gas flow | 2.68 |
| Example 4 | | (nano-crystalline) | atomization method | | |
| Comparative | Fe_{93.3}Si_{6.7} | Crystalline | Water atomization | In air/gas flow | 3.66 |
| Example 5 | | | method | | |
| Comparative | Fe_{93.3}Si_{6.7} | Crystalline | Water atomization | In air/gas flow | 1.14 |
| Example 6 | | | method | | |

| | Configuration of Fe-based alloy soft magnetic powder | | | | | |
|---|---|---|---|---|---|---|
| | | | Ratio of | | | |
| | | | particle having | | | Configuration of |
| | | | circularity | Coercive | Saturation | insulating film |
| | D90 | D90/D50 | CI of 0.60 or less | force | magnetization | Composition |
| | μm | — | % | A/m | T | — |
| Example 1 | 1.14 | 1.52 | 0.5 | 112 | 1.26 | Silicon oxide |
| Example 2 | 1.42 | 1.53 | 0.8 | 112 | 1.26 | Silicon oxide |
| Example 3 | 0.75 | 1.44 | 0.6 | 56 | 1.41 | Silicon oxide |
| Example 4 | 0.88 | 1.38 | 0.9 | 56 | 1.41 | Silicon oxide |
| Example 5 | 0.88 | 1.76 | 1.5 | 800 | 1.96 | Silicon oxide |
| Example 6 | 1.86 | 1.55 | 0.7 | 800 | 1.96 | Silicon oxide |
| Comparative | 5.68 | 1.62 | 2.3 | 113 | 1.24 | Silicon oxide |
| Example 1 | | | | | | |
| Comparative | 1.74 | 2.05 | 3.1 | 113 | 1.24 | Silicon oxide |
| Example 2 | | | | | | |
| Comparative | 10.80 | 1.93 | 2.4 | 57 | 1.39 | Silicon oxide |
| Example 3 | | | | | | |
| Comparative | 12.40 | 4.63 | 5.0 | 57 | 1.39 | Silicon oxide |
| Example 4 | | | | | | |
| Comparative | 6.35 | 1.73 | 2.3 | 800 | 1.96 | Silicon oxide |
| Example 5 | | | | | | |
| Comparative | 3.06 | 2.68 | 4.0 | 800 | 1.96 | Silicon oxide |
| Example 6 | | | | | | |

As shown in Table 1, in each Example, both the particle diameter D50 and the ratio of D90/D50 are within a predetermined range. In each Example and each Comparative Example, the average thickness of the insulating film is in a range of 20 nm to 50 nm.

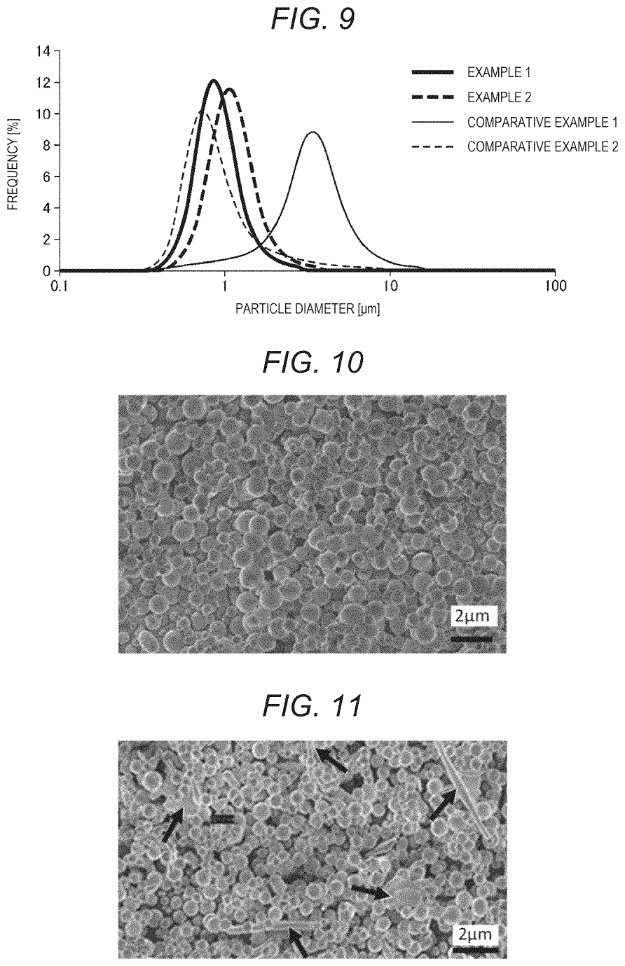

FIG. 9 is a graph obtained by comparing particle size distributions obtained from the Fe-based alloy soft magnetic powders in Examples 1 and 2 and Comparative Examples 1 and 2. As shown in FIG. 9, the Fe-based alloy soft magnetic powders in Examples 1 and 2 have a smaller peak position corresponding to the particle diameter D50 and a narrower spread of a peak corresponding to the ratio of D90/D50 as compared with the Fe-based alloy soft magnetic powders in Comparative Examples 1 and 2.

FIG. 10 is an observation image of the Fe-based alloy soft magnetic powder in Example 1 obtained by the scanning electron microscope. FIG. 11 is an observation image of the Fe-based alloy soft magnetic powder in Comparative Example 2 obtained by the scanning electron microscope. In FIG. 10, most of particle images form a perfect circle, and the particle diameters are relatively uniform. On the other hand, in FIG. 11, coarse particles as shown by arrows are observed. The coarse particles generally have irregular shapes such as needles and scales. Therefore, when the coarse particles are mixed, the circularity CI of the Fe-based alloy soft magnetic powder tends to decrease.

### 7. Evaluation of Insulating Material-coated Soft Magnetic Powder

### 7.1. Saturation Magnetic Flux Density

The saturation magnetic flux density of the insulating material-coated soft magnetic powder in each Example and each Comparative Example was measured using a VSM system TM-VSM1230-MHHL manufactured by Tamakawa Co., Ltd. serving as a magnetization measuring device. Measurement results are shown in Table 2.

### 7.2. Magnetic Loss (Core Loss) of Dust Core

The magnetic loss (core loss) of the insulating material-coated soft magnetic powder in each Example and each Comparative Example was measured by the following method.

First, a toluene solution containing an epoxy resin as a binder was mixed with the insulating material-coated soft magnetic powder, and then dried to form a mass. An addition amount of the epoxy resin was set to 2 parts by mass with respect to 100 parts by mass of the insulating material-coated soft magnetic powder. The obtained mass was pulverized, then the pulverized product was sieved with a sieve having a mesh opening of 400 μm, and the pulverized product passed through the sieve was dried at 50° C. for 1 hour.

Next, the dried product was press-formed into a ring shape having an outer diameter of 28 mm, an inner diameter of 14 mm, and a thickness of 5 mm at a molding pressure of 98 MPa. Thereafter, the obtained molded body was heated in an air atmosphere at 150° C. for 0.75 hours to form a toroidal core.

Next, a core loss Pcv of the obtained toroidal core was measured using an impedance analyzer. As measurement conditions, conditions of the number of turns of the primary coil and the number of turns of the secondary coil were 7 turns, a wire diameter of a winding wire was 0.8 mm, and a measurement frequency was 1 MHz and 5 MHz, respectively. Measurement results are shown in Table 2.

### 7.3. Mechanical Strength of Dust Core

The radial crushing strength of the toroidal core (dust core) obtained by the insulating material-coated soft magnetic powder in each Example and each Comparative Example was measured by a radial crushing strength test method specified in JIS Z 2507:2000. Measurement results are shown in Table 2. The measurement for a part of the toroidal cores was omitted.

TABLE 2

| | Evaluation results of insulating material-coated soft magnetic powder | | | |
|---|---|---|---|---|
| | Saturation magnetic | Magnetic loss (core loss) | | Radial crushing |
| | flux density | 1 MHz | 5 MHz | strength |
| | T | kW/m³ | kW/m³ | N/mm² |
| Example 1 | 1.2 | 500 | 1000 | 5.2 |
| Example 2 | 1.4 | 800 | 1500 | — |
| Example 3 | 1.3 | 200 | 400 | 5.3 |
| Example 4 | 1.5 | 300 | 600 | — |
| Example 5 | 1.7 | 1800 | 3600 | 5.1 |
| Example 6 | 1.7 | 2000 | 3800 | — |
| Comparative | 0.9 | 3000 | 10000 | — |
| Example 1 | | | | |
| Comparative | 1.0 | 2500 | 4000 | 2.4 |
| Example 2 | | | | |
| Comparative | 0.9 | 2600 | 5200 | — |
| Example 3 | | | | |
| Comparative | 1.0 | 2200 | 4000 | 2.3 |
| Example 4 | | | | |
| Comparative | 1.1 | 8900 | 25000 | — |
| Example 5 | | | | |
| Comparative | 1.2 | 7500 | 20000 | 2.4 |
| Example 6 | | | | |

As shown in Table 2, the insulating material-coated soft magnetic powder in each Example has a core loss in the high frequency band lower than that of the insulating material-coated soft magnetic powder in each Comparative Example. Considering that no difference is found in coercive force, a difference in this core loss is presumed to be based on a difference in eddy current loss. Therefore, it is confirmed that from the insulating material-coated soft magnetic powder according to the present disclosure, it is possible to obtain a magnetic element in which an eddy current loss in the high frequency band is sufficiently prevented.

### 8. Mixing of Insulating Material-Coated Soft Magnetic Powder (Small-Diameter Side Powder) and Large-Diameter Soft Magnetic Powder (Large-Diameter Side Powder)

### 8.1. Example 7

First, the insulating material-coated soft magnetic powder in Example 1 was taken as the “small-diameter side powder”, and the separately prepared large-diameter insulating material-coated soft magnetic powder was taken as the “large-diameter side powder”, and the small-diameter side powder and the large-diameter side powder were mixed to obtain a mixed powder. The large-diameter insulating material-coated soft magnetic powder is a powder including a large-diameter soft magnetic powder having a particle diameter D50 of 30 μm and an insulating film with which the particle surface of the large-diameter soft magnetic powder is coated. A formation method, a thickness, and the like of the insulating film are the same as those of the insulating material-coated soft magnetic powder in Example 1. A mixing ratio of the small-diameter side powder to the large-diameter side powder was 2:8 in terms of mass ratio.

### 8.2. Examples 8 and 9

Mixed powders were obtained in the same manner as in Example 7 except that small-diameter side powders, large-diameter side powders, and mixing ratios were changed as shown in Table 3.

### 8.3. Comparative Examples 7 to 9

Mixed powders were obtained in the same manner as in Example 7 except that small-diameter side powders, large-diameter side powders, and mixing ratios were changed as shown in Table 3.

TABLE 3

| | Configuration of mixed powder | | | | | | | | |
|---|---|---|---|---|---|---|---|---|---|
| | | | | | | | | Mixing ratio | |
| | | | | | | | | of small- | |
| | | | | | | | | diameter | |
| | | | | | | | | side powder | |
| | Small-diameter side powder | | | | Large-diameter side powder | | | to large- | Configuration of |
| | Alloy | Crystal | | | Alloy | Crystal | | diameter | insulating film |
| | composition | structure | D50 | D50/D90 | composition | structure | D50 | side powder | Composition |
| | — | — | μm | — | — | — | μm | — | — |
| Example 7 | Same as | Non-crystalline | 0.75 | 1.52 | Same as | Non-crystalline | 30 | 2:8 | Silicon oxide |
| | Example 1 | (amorphous) | | | Example 1 | (amorphous) | | | |
| Example 8 | Same as | Microcrystalline | 0.52 | 1.44 | Same as | Non-crystalline | 30 | 3:7 | Silicon oxide |
| | Example 3 | (nano-crystalline) | | | Example 1 | (amorphous) | | | |
| Example 9 | Same as | Microcrystalline | 0.52 | 1.44 | Same as | Microcrystalline | 35 | 2:8 | Silicon oxide |
| | Example 3 | (nano-crystalline) | | | Example 3 | (nano-crystalline) | | | |
| Comparative | Same as | Non-crystalline | 0.85 | 2.05 | Same as | Non-crystalline | 30 | 2:8 | Silicon oxide |
| Example 7 | Comparative | (amorphous) | | | Example 1 | (amorphous) | | | |
| | Example 2 | | | | | | | | |
| Comparative | Same as | Microcrystalline | 2.68 | 4.63 | Same as | Non-crystalline | 30 | 3:7 | Silicon oxide |
| Example 8 | Comparative | (nano-crystalline) | | | Example 1 | (amorphous) | | | |
| | Example 4 | | | | | | | | |
| Comparative | Same as | Microcrystalline | 2.68 | 4.63 | Same as | Microcrystalline | 35 | 2:8 | Silicon oxide |
| Example 9 | Comparative | (nano-crystalline) | | | Example 3 | (nano-crystalline) | | | |
| | Example 4 | | | | | | | | |

### 9. Evaluation of Mixed Powder

### 9.1. Saturation Magnetic Flux Density

The saturation magnetic flux density of the mixed powder in each Example and each Comparative Example was measured using a VSM system TM-VSM1230-MHHL manufactured by Tamakawa Co., Ltd. serving as a magnetization measuring device. Measurement results are shown in Table 4.

### 9.2. Magnetic Loss (Core Loss) of Dust Core

The magnetic loss (core loss) of the mixed powder in each Example and each Comparative Example was measured by the same method as 7.2 described above. Measurement results are shown in Table 4.

TABLE 4

| | Evaluation results of mixed powder | | |
|---|---|---|---|
| | Saturation magnetic | Magnetic loss (core loss) | |
| | flux density | 1 MHz | 5 MHz |
| | T | kW/m³ | kW/m³ |
| Example 7 | 1.6 | 900 | 1800 |
| Example 8 | 1.7 | 500 | 1000 |
| Example 9 | 1.8 | 400 | 800 |
| Comparative | 1.0 | 3000 | 4500 |
| Example 7 | | | |
| Comparative | 1.1 | 2800 | 4300 |
| Example 8 | | | |
| Comparative | 1.2 | 2500 | 4100 |
| Example 9 | | | |

As shown in Table 4, the core loss of the mixed powder in the high frequency band in each Example is lower than that of the mixed powder in each Comparative Example. Therefore, even when the mixed powder is used, it is confirmed that from the insulating material-coated soft magnetic powder according to the present disclosure, it is possible to obtain a magnetic element in which an eddy current loss in the high frequency band is sufficiently prevented.

What is claimed is:

1. An insulating material-coated soft magnetic powder comprising:
an Fe-based alloy soft magnetic powder; and
an insulating film with which a particle surface of the Fe-based alloy soft magnetic powder is coated, wherein
D50 is 0.1 μm or more and 3.0 μm or less, where D50 is a particle diameter of the Fe-based alloy soft magnetic powder at which a cumulative frequency is 50% in a volume-based particle size distribution, and
a ratio of D90/D50 is 2.00 or less, where D90 is a particle diameter of the Fe-based alloy soft magnetic powder at which the cumulative frequency is 90% in the volume-based particle size distribution.

2. The insulating material-coated soft magnetic powder according to claim 1, wherein
the Fe-based alloy soft magnetic powder has a coercive force of 800 A/m or less and a saturation magnetization of 1.1 T or more.

3. The insulating material-coated soft magnetic powder according to claim 1, wherein
the Fe-based alloy soft magnetic powder is an atomized powder.

4. The insulating material-coated soft magnetic powder according to claim 1, wherein
the insulating film contains a silicon oxide or a composite oxide containing silicon and at least one selected from the group consisting of Al, Ti, V, Nb, Cr, Mn, and Zr.

5. The insulating material-coated soft magnetic powder according to claim 1, wherein
the insulating film has an average thickness of 1 nm or more and 100 nm or less.

6. The insulating material-coated soft magnetic powder according to claim 1, wherein
in the Fe-based alloy soft magnetic powder, a ratio of particles having a circularity of 0.60 or less is 2.0% or less.

7. A method for producing an insulating material-coated soft magnetic powder, comprising:
an in-liquid classification step of classifying an Fe-based alloy raw material powder in a liquid, and extracting an Fe-based alloy soft magnetic powder that has D50 of 0.1 μm or more and 3.0 μm or less where D50 is a particle diameter thereof at which a cumulative frequency is 50% in a volume-based particle size distribution, and that has a ratio of D90/D50 of 2.00 or less where D90 is a particle diameter thereof at which the cumulative frequency is 90% in the volume-based particle size distribution; and
an insulating film formation step of forming an insulating film with which a particle surface of the Fe-based alloy soft magnetic powder is coated.

8. The method for producing an insulating material-coated soft magnetic powder according to claim 7, wherein
the in-liquid classification step includes an operation of classifying the Fe-based alloy raw material powder by a centrifugal force or gravity.

9. The method for producing an insulating material-coated soft magnetic powder according to claim 7, wherein
the liquid used for classifying the Fe-based alloy raw material powder contains a dispersant.

10. A dust core comprising:
the insulating material-coated soft magnetic powder according to claim 1.

11. The dust core according to claim 10, further comprising:
a large-diameter soft magnetic powder having an average particle diameter larger than that of the Fe-based alloy soft magnetic powder.

12. A magnetic element comprising:
the dust core according to claim 10.

13. An electronic device comprising:
the magnetic element according to claim 12.

14. A moving body comprising:
the magnetic element according to claim 12.
